SEQUENCE LISTING (5 sequences)

SEQ ID NO: 1 - DNA, 60 bp, Artificial Sequence
  Oligonucleotide
gtaacacgacggccagtgctcgagtttctgtattctcaaatacggtacactggtcagcga

SEQ ID NO: 2 - DNA, 70 bp, Artificial Sequence
  Oligonucleotide
gtaacacgacggccagtggtccaatcgtccaaatcgactttattgcacggaacggtacactggtcagcga

SEQ ID NO: 3 - DNA, 80 bp, Artificial Sequence
  Oligonucleotide
gtaacacgacggccagtgccattgagcattcttatgactttatatgtatttaagccgatgtgcggtacactggtcagcga

SEQ ID NO: 4 - DNA, 18 bp, Artificial Sequence
  Oligonucleotide
tcgctgaccagtgtaccg

SEQ ID NO: 5 - DNA, 18 bp, Artificial Sequence
  Oligonucleotide
gtaacacgacggccagtg

(19) United States
(12) Patent Application Publication
(10) Pub. No.: US 2004/0013872 A1
(43) Pub. Date: Jan. 22, 2004

(54) Synthetic particle used for marking a substance

(76) Inventors: Wolf Bertling, Erlangen (DE); Hans Kosak, Bonn (DE)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/343,522

(22) PCT Filed: Jul. 30, 2001
(86) PCT No.: PCT/DE01/02920

(30) Foreign Application Priority Data
Aug. 4, 2000 (DE) 100381693

(51) Int. Cl. B32B 19/00

(52) U.S. Cl. 428/357; 428/403

(57) ABSTRACT

The invention relates to a synthetic particle used for marking a substance. Said synthetic particle is comprised of a number of identification substances (10, 12), which exist in a solid form, and of at least one covering (16), which encloses at least one of the identification substances (10, 12). The identification substances (10, 12) are selected such that the synthetic particle (18) can be identified by simultaneously identifying the identification substances (10, 12) in one and the same identification method on the basis of non-optical properties of the identification substances (10, 12).

The invention relates to a synthetic particle for labeling a substance, to a use of said particle, to a method for labeling a substance and to a method for identifying a labeled substance.

Polystyrene particles into which fluorophores have been embedded irreversibly are known in the art. Such polystyrene particles are, for example, produced by estapor® and sold by KMF Laborchemie Handels GmbH, Zum Siegblick 37-39, 53757 Sankt Augustin, Federal Republic of Germany. Said polystyrene particles are used for calibration in flow cytometry. Only a small number of fluorophores is suitable for the preparation of such particles. The number of codings possible by using said particles is very limited.

WO 94/04918 discloses a method for labeling a liquid. In this case, particles containing a signaling agent which comprises not just one nucleic acid label are added to said liquid. For identification, each of the components of said signaling agent may require its own analysis for identification which is complicated. In these particles the signaling agent is in contact with the labeled liquid. An interaction between the labeled liquid and the signaling agent may occur. This may cause degradation, in particular enzymic or hydrolytic degradation, of the signaling agent. Identification of the particles is then no longer possible. When labeling oil, the nucleic acid contained in the particles as signaling agent is protected against an interaction with the oil only by water contained in said particles. If the water is removed from the particles, for example by heating, interaction of the oil with the nucleic acid renders analysis of the latter impossible. In the case of particles differing in their signaling agents, different interactions between the labeled liquid and said particles may occur. As a result, some of the particles may, for example, aggregate more readily than other particles. In a solution, aggregated particles precipitate and thereby possibly escape detection.

DE 690 28 402 T 2 discloses a method for labeling a substance with a nucleic acid. The nucleic acid may be free or bound covalently to a solid support or to a component of the substance, said nucleic acid being accessible to the labeled substance. This is associated with the disadvantages already mentioned. Instead of being bound covalently to a solid support or to a component of the substance, it is also possible for the nucleic acid to be encapsulated by a polymeric substance or a lipophilic compositions. If the nucleic acid is present in solution, the particle generated as a result of encapsulation is relatively unstable. It is unable to withstand strong shear forces arising in solutions. If the polymeric substances used are viral coat proteins, the amount of nucleic acid which can be encapsulated is relatively small and, accordingly, identification thereof is complicated.

Furthermore, particles are known which are referred to as liposomes, are enclosed by phospholipid membranes and have an inner aqueous phase. Liposomes whose aqueous phases contain dissolved nucleic acids are used for transfection in molecular biology. Liposomes have the disadvantage of being relatively unstable to shear forces in solutions.

WO 99/34984 discloses a particle for labeling substances, which consists of an encapsulated identification substance identifiable by means of infrared radiation and of a biological marker. The biological marker may be, for example, DNA. Disadvantageously, it is possible in the known particle that the biological marker is bound to the surface of said particle. As a consequence thereof, the physical, chemical or biological properties of the particle may be altered in an undesired manner. Apart from that, both an optical and a biochemical method must be carried out in order to identify the label, requiring high expenditure.

It is the object of the present invention to remove the disadvantages of the prior art. In particular, it is intended to indicate a synthetic particle for labeling a substance, in which an interaction between an identification substance and the labeled substance is ruled out until said identification substance is identified. The particle should be stable to shear forces arising in solutions. The particle should make it possible to provide a large number of different, easily identifiable codings. Furthermore, a use of the synthetic particle, a method for labeling a substance and a method for identifying a labeled substance are to be provided.

The object is achieved by the features of claims 1, 18, 21 and 22. Expedient embodiments of the invention ensue from the features of claims 2 to 17, 19 and 20 and 23 to 28.

The present invention provides for a synthetic particle for labeling a substance, comprising a plurality of identification substances in solid form and at least one closed coating surrounding said identification substances, said identification substances being selected in such a way that the synthetic particle can be identified by simultaneously identifying said identification substances in one and the same identification method, owing to nonoptical properties of said identification substances. An example of an optical property is a particular fluorescence. There is only a limited number of identification substances which can be identified unambiguously by their optical properties. Identification substances which can be identified owing to nonoptical properties can provide substantially more codings. Combining a plurality of such identification substances can provide an even larger number of different codings.

The closed coating prevents the substance labeled with the synthetic particle or a substance surrounding the synthetic particle from being able to interact with the identification substance until the latter is identified. The identification substance is protected from being degraded or altered in such a way that later identification is no longer possible. The identification substance, in particular, does not appear on the surface of the synthetic particle; the surface of the particles is always composed in a chemically uniform way. Synthetic particles with different identification substances and the same coating behave toward the labeled substance in the same way. The coating reacts with the labeled substance only slowly, if at all. A coating reacting slowly with the substance has the advantage that it is possible to degrade the synthetic particles in the period after the intended identification, so that no particles remain. The coating is normally opened for identifying the identification substances. The coating may be opened, for example, by dissolving it by means of a solvent. It is also possible to physically open the coating, for example by heating or by means of a laser beam.

Selection of the identification substances makes it possible to identify them simultaneously in one and the same identification method. In this case, the identification substances are analyzed together. It is not necessary to separate the identification substances beforehand in order to introduce them to specific identification methods. This ensures easy identification of the codings. In order to be identified, the identification substances must have similar specific properties with respect to the identification method chosen. For example, identification substances to be identified by their molecular weights must be selected such that their molecular weights are within a range which can be resolved by the identification method chosen. The method may be an analysis by mass spectrometry, which allows simultaneous determination of the molecular weights of all identification substances in a single spectrum.

The solid form of the identification substances ensures high stability of the synthetic particles, in particular to shear forces arising in solutions. The solid form may be guaranteed by the identification substances themselves. If the identification substances consist of nucleic acids, the solid form can be attained, for example, by precipitation with alcohol. The identification substances may also be immobilized to an excipient or they form a precipitate together with said excipient. An identification substance in solid form can attain a higher substance density than an identification substance in solution. An amount of identification substances which is sufficient for identification can fit into a relatively small synthetic particle. The solid form makes it possible to prepare the particles by simply coating the identification substances with a material forming the coating.

The coating may contain proteins, peptides, polyols, polymers, wax, lipids, metal, biotin, streptavidin or avidin. It may furthermore have coupling groups, in particular amino, thiol, tosyl, carboxyl, epoxy, carbonyl, aldehyde, antigen, antibody, biotin, streptavidin or avidin groups. These coupling groups enable molecules to bind to the coating. In particular, they also enable the substance to be labeled to be bound to the coating.

The identification substances may be selected from a group consisting of metal, metal ions, different isotopes of an element, preferably lanthanides and isotopes thereof, low molecular weight substances, including sugar residues, alcohol residues, amino acid residues, analogs thereof, modified amino acid residues, nucleotides, analogs thereof, modified nucleotides and/or PNA (peptide nucleic acid) or a polymer of at least one of said low molecular weight substances. The polymer preferably consists of from 3 to 600 monomers.

At least one further molecule may be bound to the outside of the coating. Said further molecule may be a protein, such as a DNA-binding protein or an antibody, a nucleic acid, avidin, streptavidin, biotin, a superparamagnetic or fluorescent particle or a fluorophore. Said further molecule makes it possible to sort out the synthetic particle from the substance or from a liquid containing said synthetic particle. The molecule may furthermore have an affinity for a substance contained in the substance. The presence of the former substance in the labeled substance can be detected by detecting the substance bound to the particles. This is particularly advantageous in the case of a multiplicity of different reaction mixtures labeled with different particles of the invention, for example in the case of a high-throughput screening method. It is possible, by identifying the particles containing the bound substance, to identify those reaction mixtures in which the substance is present.

The synthetic particle preferably contains at least one excipient. The excipient may contain at least one member of a group consisting of agent for precipitating the identification substance, polyanion, artificial or natural polymer, fluorophore, microcapsule, nanocapsule, microparticle, nanoparticle, peptide or protein, polylysine or a derivative thereof, protamine or a derivative thereof, silica particle, polystyrene particle, polystyrene/copolymer particle, polyvinyl chloride particle, polyethylene particle, nylon particle, polymethacrylate particle, polyvinyltoluene particle, glass particle, particle of porous material, of a protein, of CPG (controlled pore glass), starch, agarose, polyacrylamide, Wang, Rink, Merrifield resin and metal particle. The metal particles may be gold particles or tungsten particles. The excipient is preferably a peptide or protein which has, in particular, a molecular weight in the range from 3900 to 4300 and which can form a particle together with at least one of the identification substances. DE 198 58 005, the disclosure of which is incorporated, describes the generation of such a particle with the sequence of a nucleic acid or of a nucleic acid derivative.

The excipient may have amino, thiol, tosyl, carboxyl, epoxy, carbonyl, aldehyde, antigen, biotin, streptavidin, avidin, or fluorophore groups. Preferably, at least one of the identification substances is bound to the inside of the coating or, in particular via any of the groups mentioned, to the excipient. At least one of the identification substances may be bound to the inside of the coating by means of the coupling groups or of a crosslinker.

The identification substances may be identifiable owing to their molecular weight, their sequence, their sequence length and/or their particular weight relative to the weight of the identification substances present in the synthetic particle. The molecular weight can be identified by means of mass spectrometry, in particular MALDI-TOF. Here, the identification substances may be, for example, peptides or metal ions which can be distinguished unambiguously by their behavior in mass spectrometry.

The diameter of the synthetic particle is preferably between 1 mm and 0.2 μm, in particular between 20 μm and 0.5 μm. The synthetic particle may be fluorescent, superparamagnetic, colored, light-scattering or electrically charged. A superparamagnetic particle means a particle which shows magnetic behavior only in a magnetic field.

In a preferred embodiment, the identification substances contained in the synthetic particle are selected from a predetermined group of identification substances which can be distinguished from one another unambiguously. Thus, when identifying synthetic particles containing identification substances from defined sections of said group, there is a possibility of controlling the identification process: if no identification substance of any of the sections or of all sections is identified, the identification process contains an error.

The invention furthermore relates to the use of an inventive synthetic particle for labeling a substance. Labeling may be carried out by adding the particle to the substance. The synthetic particle can bind to the substance or the substance can be bound to the surface of the synthetic particle. The synthetic particle may also be contained in the substance, without interacting therewith. The substance may be a living cell. Preferably, the synthetic particle is introduced into a living cell. This makes it possible to take a labeled substance into the cell interior or to label the cell itself. The substance introduced into the cell can trigger a reaction there and be identified later by the particle. In order to introduce the synthetic particle into a living cell, particular preference is given to the excipient being a metal particle so that the synthetic particle has a high density. Then it is possible to fire the synthetic particles onto cells by means of a “gene gun”. A subset of the particles enters the cells in the process. The invention further relates to a method for labeling a substance with a synthetic particle, said synthetic particle consisting of at least one identification substance which can be identified owing to nonoptical properties and of at least one closed coating surrounding the identification substance, said substance being bound to the outside of said coating. The identification substance may be present in solid form. Using particles with in each case only one identification substance is advantageous if various labeled substances are to be identified simultaneously in a single process. The coating is opened for identification of the identification substance.

In addition, the invention relates to a method for identifying a substance labeled with a synthetic particle of the invention. In this case, the coating is opened and the synthetic particle is identified by simultaneously identifying the identification substances in one and the same identification method owing to nonoptical properties of said identification substances. At least one of the identification substances may be a nucleic acid which is duplicated prior to identifying, for example by using a PCR. At least one of the identification substances can be identified on the basis of its molecular weight, its sequence, its sequence length and/or its weight relative to the weight of the identification substances present in the synthetic particle. Expediently, the identification substances can be identified by means of mass spectrometry. The synthetic particle may be fluorescent, superparamagnetic, colored, light-scattering or electrically charged and may be sorted out for identifying owing to any of these properties. It is also possible to identify the identification substances by means of an electrochemical method. For this purpose, conventional electrochemical methods familiar to the skilled worker may be used. The synthetic particle may be sorted out from the substance by means of an apparatus suitable for flow cytometry.

In the following the invention is illustrated in more detail by the drawing and on the basis of exemplary embodiments. In the drawings,

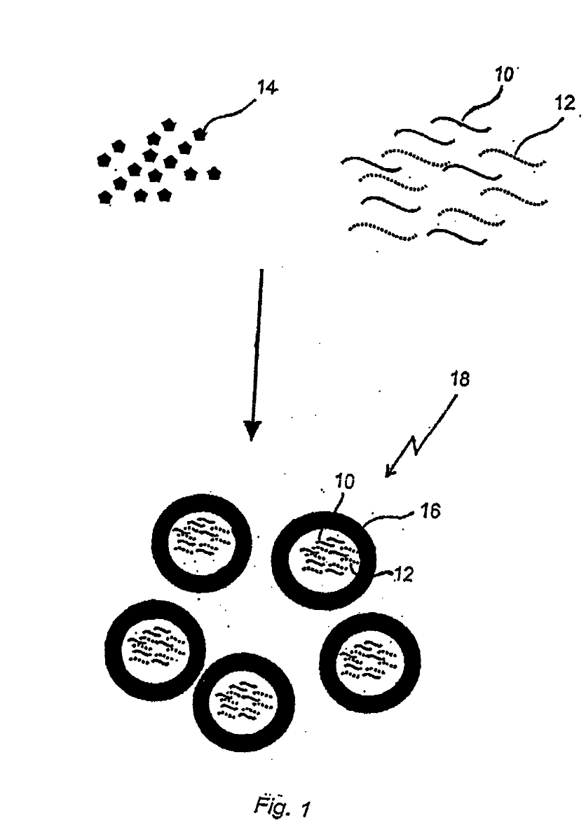

FIG. 1 shows a diagrammatic representation of the process of coating identification substances,

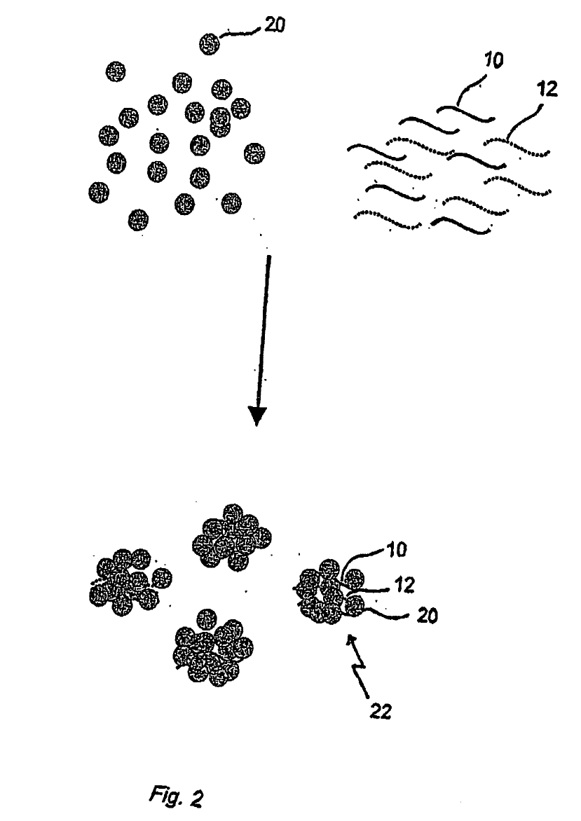

FIG. 2 shows a diagrammatic representation of the aggregation of identification substances with an excipient,

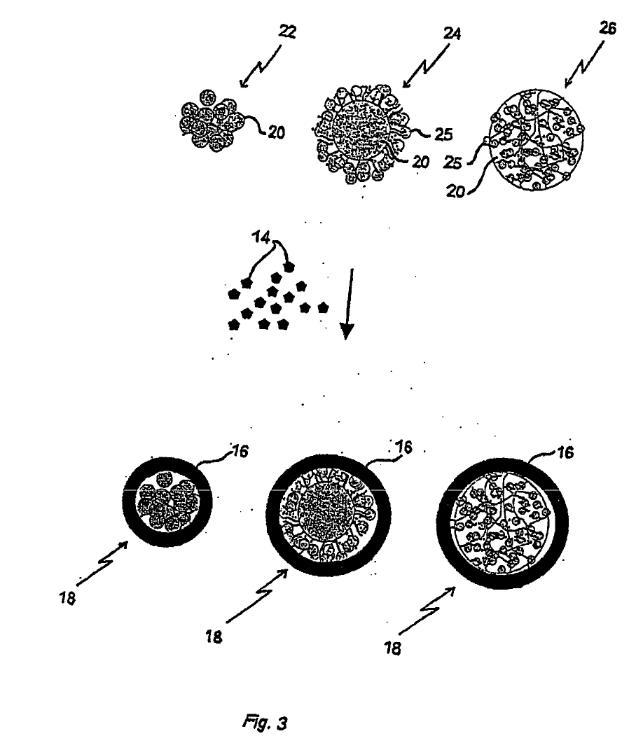

FIG. 3 shows the diagrammatic representation of the coating of identification substances aggregated with an excipient,

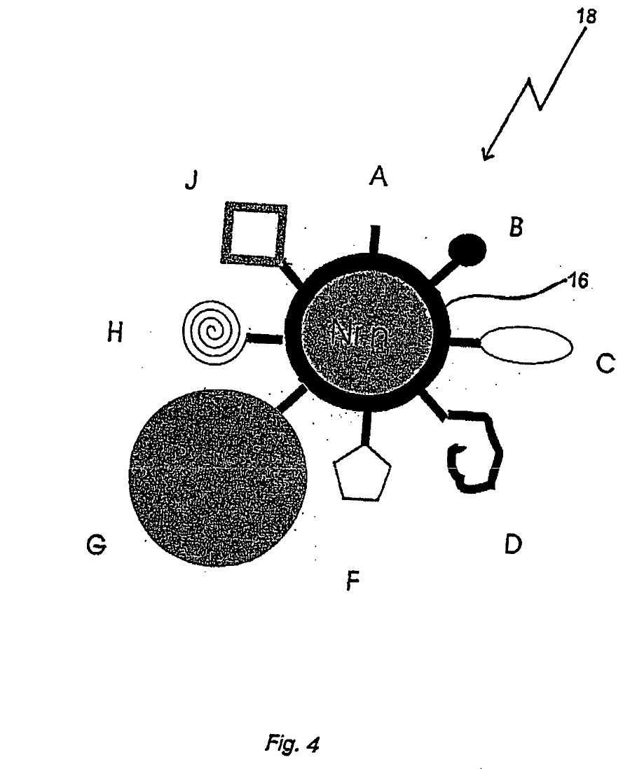

FIG. 4 shows a diagrammatic representation of a synthetic particle of the invention, containing coupling groups and further molecules on the outside of the coating,

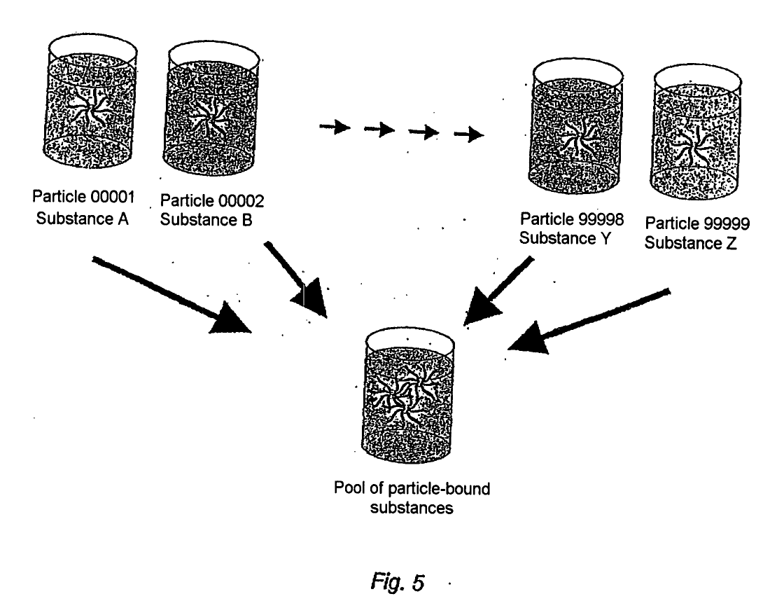

FIG. 5 shows a diagrammatic representation of various reaction mixtures in which in each case a substance is bound to the surface of synthetic particles,

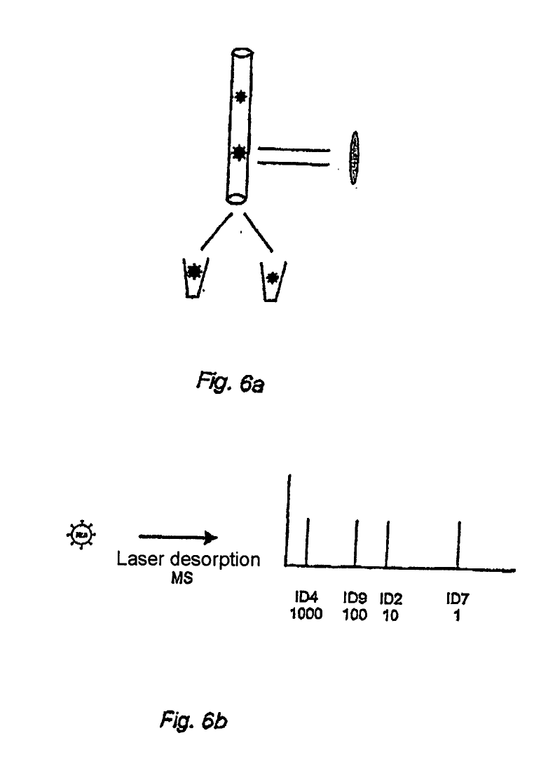

FIGS. 6a and 6b show a diagrammatic representation of sorting out and identifying a synthetic particle by means of mass spectrometry, and

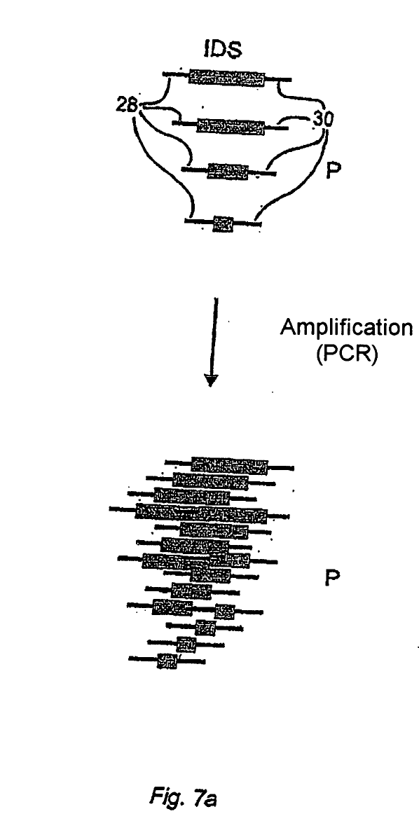

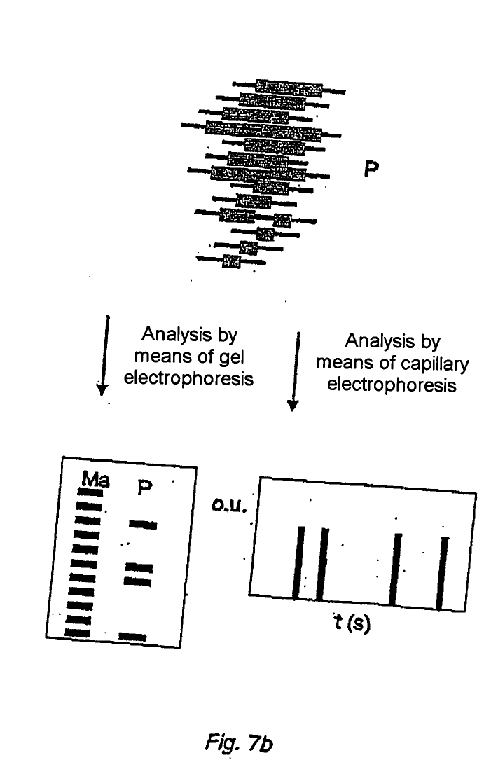

FIGS. 7a and 7b show a diagrammatic representation of coding and identification of a number by a combination of nucleic acids of different length.

FIG. 1 depicts diagrammatically the process of coating of the identification substances 10, 12 by the molecules 14 forming the coating. The molecules 14 forming the coating are mixed with the identification substances 10, 12, resulting in synthetic particles 18 in which the identification substances 10, 12 are enclosed by the closed coating 16. Methods for preparing closed coatings are described, for example, in U.S. Pat. No. 3,856,966, U.S. Pat. No. 3,664,963, U.S. Pat. No. 4,637,905, U.S. Pat. No. 3,664,963 and U.S. Pat. No. 4,089,800, the disclosure of which is hereby incorporated.

FIG. 2 depicts diagrammatically the aggregation of the identification substances 10, 12 with the excipient 20. The identification substances 10, 12 may be nucleic acids and the excipient may be protamine. Contacting the identification substances 10, 12 with the excipient 20 leads to aggregation. The identification substances 10, 12 precipitate, together with the excipient 20, as particles 22.

FIG. 3 shows the process of coating a particle 22, a particle 24 with identification substances 10, 12 bound on the surface of an excipient 20, and a porous particle 26 with identification substances 10, 12 bound to a porous excipient 20. A further substance 25 may be bound to the identification substances 10, 12. The particles 22, 24, 26 are contacted with the molecules 14 forming the coating. A closed coating 16 is formed around the particles 22, 24, 26.

FIG. 4 shows diagrammatically surface modifications on the closed coating 16 of a synthetic particle 18 of the invention. The surface modifications may be present on the synthetic particle 18 individually or in combination. A refers to a coupling group. B, C, D, F, G, H and J refer to further molecules bound to coupling groups A, such as antibodies, streptavidin/avidin, ligands, receptors, superparamagnetic or fluorescent particles, fluorophores or nucleic acids.

FIG. 5 shows diagrammatically various reaction mixtures in which in each case a substance is bound to the surface of the synthetic particles 18 of the invention. Each substance can be identified unambiguously by the synthetic particle 18. Synthetic particles 18 containing bound substances are removed from each reaction mixture and combined in a joint mixture. The substances may be subjected together to a reaction such as, for example, binding of an antibody. Synthetic particles 18 containing antibodies bound to the substances may be selected, for example, owing to fluorescence labeling of said antibodies. The substances bound by the antibodies can be identified by the synthetic particles 18.

FIG. 6a shows diagrammatically the sorting out of synthetic particles 18 from the joint mixture by means of a fluorescence-activated particle sorter. The identification substances in the synthesized particles 18 are characterized by their mass. FIG. 6b shows diagrammatically identification of a synthetic particle 18 by mass spectrometry. This may be carried out, for example, by means of MALDI-TOF. Each identification substance codes for a digit of a decimal place of a number. This number makes it possible to identify the reaction mixture from which the particle originates. The method makes it possible to check a multiplicity of reaction mixtures in a short time.

FIGS. 7a and 7b show diagrammatically, how information can be coded and identified by a combination of nucleic acids of a different sequence length P as identification substances. The nucleic acids depicted in FIG. 7a have primer binding sequences 28 and 30 which are identical or deviate from one another. The nucleic acids are amplified with the aid of a PCR. FIG. 7b shows diagrammatically the analysis of the amplified nucleic acids by means of gel or capillary electrophoresis. In the case of gel-electrophoretic analysis, comparison with marker nucleic acids MA fractionated gel-electrophoretically at the same time allows identification of the amplified nucleic acids. In the case of capillary-electrophoretic analysis, each of the amplified nucleic acids generates a signal which can be measured in optical units o.u. Each signal has a delay time t which is characteristic for one of the nucleic acids. Alternatively, the amplified nucleic acids may also be analyzed by mass spectrometry.

A synthetic particle 18 is prepared by providing oligonucleotides having the sequences SEQ ID NO 1, SEQ ID NO 2 and SEQ ID NO 3 according to the attached sequence listing. Their sequences are 60, 70 and 80 bases in length. In each case identical primer binding sequences are located 3′- and 5′-terminally. A region with a length characteristic for each sequence is located in between. The oligonucleotide having the sequence SEQ NO 1 is labeled on its 5′ end with 5[6]-carboxyfluorescein (FAM). In each case 100 μg/ml oligonucleotides are dissolved in double-distilled water. The solutions are combined and 300 μl of a solution containing 50 μg/ml protamine are added. The mixture is agitated vigorously at room temperature for one minute. This results in spontaneous particle formation which is complete after half an hour. This method is described in DE 198 58 005. The particles formed are removed by centrifugation and washed in double-distilled water. The average particle diameter is 0.9 μm. 100 μl of a suspension containing 1% by volume of the particles are suspended in water at 65° C. together with 10 mg of paraffin which has a melting point of 60° C. and cooled rapidly by adding ice water with stirring. Coated particles form in the process. The particles are washed by centrifuging and suspending them repeatedly.

The particles are added to a solution to be labeled. In order to isolate a particle from this solution, said solution containing the particles is spread out on a slide. The particles on the slide are visible under a fluorescence microscope owing to FAM labeling. A single particle is taken up using a finely drawn-out glass capillary. A particle may also be isolated by means of a fluorescence-activated particle sorter. The particle is transferred in a total volume of approx. 1 μl into a 100 μl PCR reaction vessel. For identification, a hot start PCR is carried out using the Taq PCR kit from Roche Diagnostics GmbH in a total volume of 20 μl. For this purpose, the following PCR protocol is carried out after adding the primers having the sequences SEQ ID NO 4 and SEQ ID NO 5:

1. 10 minutes at 95° C.,

2. 1 minute at 95° C.,

3. 30 seconds at 58° C.,

4. 30 seconds at 72° C.,

5. 35 cycles 2. to 4., and

6. one hour at 4° C.

10 μl of the PCR mixture are fractionated on a 15% polyacrylamide minigel in Tris-acetate-EDTA buffer at 100 V for 1.5 hours. The size marker used is a 10 base-pair ladder from Roche Diagnostics GmbH. The DNA bands are stained by means of ethidium bromide and visualized on a UV transilluminator at 305 nm. The size of the PCR products is determined by comparison with the 10 base-pair ladder. PCR products of 60, 70 and 780 base pairs in length are visible.

### LIST OF REFERENCE NUMBERS

10 Identification substance

12 Identification substance

14 Coating-forming molecule

16 Coating

18 Synthetic particle

20 Excipient

22 Particle

24 Particle

25 Further substance

26 Particle

28 Primer binding sequence

30 Primer binding sequence

IDS Identification sequence

A Coupling group

B, C, D, E, G, H, J Further molecules

P Combination of nucleic acids

of different sequence length

o.u. Optical unit

t Delay time

1. A synthetic particle for labeling a substance, comprising a plurality of identification substances (10, 12) in solid form and at least one closed coating (16) surrounding said identification substances (10, 12), said identification substances (10, 12) being selected in such a way that the synthetic particle (18) can be identified by simultaneously identifying said identification substances (10, 12) in one and the same identification method, owing to nonoptical properties of said identification substances (10, 12).

2. The synthetic particle claimed in claim 1, in which identification substances are not present on one outside of the coating.

3. The synthetic particle as claimed in claim 1 or 2, in which the coating (16) comprises proteins, peptides, polyols, polymers, wax, lipids, metal, biotin, streptavidin or avidin.

4. The synthetic particle as claimed in any of the preceding claims, in which the coating (16) has coupling groups (A), in particular amino, thiol, tosyl, carboxyl, epoxy, carbonyl, aldehyde, antigen, antibody, biotin, streptavidin or avidin groups.

5. The synthetic particle as claimed in any of the preceding claims, in which the identification substances (10, 12) are selected from a group consisting of metal, metal ions, different isotopes of an element, preferably lanthanides and isotopes thereof, low molecular weight substances, including sugar residues, alcohol residues, amino acid residues, analogs thereof, modified amino acid residues, nucleotides, analogs thereof, modified nucleotides and/or PNA or a polymer of at least one of said low molecular weight substances.

6. The synthetic particle as claimed in claim 5, in which the polymer is composed of from 3 to 600 monomers.

7. The synthetic particle as claimed in any of the preceding claims, in which at least one further molecule (B, C, D, E, G, H, J) is bound to the outside of the coating (16).

8. The synthetic particle as claimed in claim 7, in which the further molecule (B, C, D, E, G, H, J) is a protein, a nucleic acid, avidin, streptavidin, biotin, a superparamagnetic or fluorescent particle or a fluorophore.

9. The synthetic particle as claimed in any of the preceding claims, which synthetic particle (18) comprises at least one excipient (20).

10. The synthetic particle as claimed in claim 9, in which the excipient (20) comprises at least one member of a group consisting of precipitating agents for at least one of the identification substances, polyanion, artificial or natural polymer, fluorophore, microcapsule, nanocapsule, microparticle, nanoparticle, peptide or protein, polylysine or a derivative thereof, protamine or a derivative thereof, silica particle, polystyrene particle, polystyrene/copolymer particle, polyvinyl chloride particle, polyethylene particle, nylon particle, polymethacrylate particle, polyvinyltoluene particle, glass particle, particle of porous material, of a protein, of CPG, starch, agarose, polyacrylamide, Wang, Rink, Merrifield resin and metal particle.

11. The synthetic particle as claimed in claim 9 or 10, in which the excipient (20) has amino, thiol, tosyl, carboxyl, epoxy, carbonyl, aldehyde, antigen, biotin, streptavidin, avidin or fluorophore groups.

12. The synthetic particle as claimed in any of the preceding claims, in which at least one of the identification substances (10, 12) is bound on the inside of the coating (16) or to the excipient (20).

13. The synthetic particle as claimed in any of the preceding claims, in which at least one of the identification substances (10, 12) is bound to the inside of the coating (16) by means of any of the coupling groups (A) or of a crosslinker.

14. The synthetic particle as claimed in any of the preceding claims, in which the identification substances (10, 12) can be identified due to their molecular weight, their sequence, their sequence length and/or their particular weight relative to the weight of the identification substances (10, 12) present in the synthetic particle (18).

15. The synthetic particle as claimed in any of the preceding claims, in which the synthetic particle (18) has a diameter of between 1 mm and 0.2 μm, in particular between 20 μm and 0.5 μm.

16. The synthetic particle as claimed in any of the preceding claims, in which the synthetic particle (18) is fluorescent, superparamagnetic, colored, light-scattering or electrically charged.

17. The synthetic particle as claimed in any of the preceding claims, in which the identification substances (10, 12) are selected from a predetermined group of identification substances which differ unambiguously from one another.

18. The use of a synthetic particle as claimed in any of claims 1-17 for labeling a substance.

19. The use as claimed in claim 18, in which the substance is bound to the surface of the synthetic particle.

20. The use as claimed in claim 18 or 19, in which the substance is a living cell.

21. A method for labeling a substance with a synthetic particle, in which method the synthetic particle (18) consists of at least one identification substance (10, 12) which can be identified owing to nonoptical properties and of at least one closed coating (16) surrounding said identification substance (10, 12), with said substance being bound to the outside of said coating.

22. A method for identifying a substance labeled with a synthetic particle as claimed in any of claims 1-17, in which the coating (16) is opened and the synthetic particle (18) is identified by simultaneously identifying the identification substances (10, 12) in one and the same identification method, owing to nonoptical properties of said identification substances (10, 12).

23. The method as claimed in claim 22, in which at least one of the identification substances (10, 12) is a nucleic acid which is duplicated prior to identifying.

24. The method as claimed in claim 22 or 23, in which at least one of the identification substances (10, 12) is identified owing to its molecular weight, its sequence, it sequence length and/or its weight relative to the weight of the identification substances (10, 12) present in the synthetic particle (18).

25. The method as claimed in any of claims 22-24, in which the identification substances are identified by means of mass spectrometry.

26. The method as claimed in any of claims 22-25, in which the synthetic particle (18) is fluorescent, superparamagnetic, colored, light-scattering or electrically charged and is sorted on the basis of one of these properties.

27. The method as claimed in any of claims 22-26, in which the identification substances are identified by means of an electrochemical method.

28. The method as claimed in any of claims 22-27, in which the synthetic particle (18) is sorted out of the substance by means of an apparatus suitable for flow cytometry.
